(19) United States
(12) Patent Application Publication
(10) Pub. No.: US 2023/0006314 A1
(43) Pub. Date: Jan. 5, 2023

(54) Electrochemical device for storing electrical energy in rectangular geometric cells

(71) Applicants: Camilo Merino Gonzalez, Madrid (ES); Enrique Navarro Romero, Madrid (ES)

(72) Inventors: Camilo Merino Gonzalez, Madrid (ES); Enrique Navarro Romero, Madrid (ES)

(21) Appl. No.: 17/386,559

(22) Filed: Jul. 28, 2021

(30) Foreign Application Priority Data
Jun. 30, 2021 (EP) 21182750.6

(51) Int. Cl. H01M 50/54; H01M 50/131; H01M 50/103; H01M 10/42; H01M 10/613; H01M 10/647; H01M 10/6554; H01M 10/6561

(52) U.S. Cl. CPC H01M 50/54; H01M 50/131; H01M 50/103; H01M 10/4235; H01M 10/613; H01M 10/647; H01M 10/6554; H01M 10/6561

(57) ABSTRACT

Electrochemical device for storing electrical energy in rectangular geometric cells, narrow stack geometry, according to the above claims wherein for being built from a sturdy housing (4) in the form of a straight rectangular parallelepiped and where hollow metal rods (5) run on the metal substrate (14) of the base (1) and through the through holes (16) of the base (16) and through the through holes (16) of it run hollow metal rods (5) and on each one of them, the positive electrode is inserted followed by a separating element and so on, while the other hollow metal bar (5) is inserted the negative electrode, followed by a separating element and so on forming a “stack” of electrodes (6) which would fit into the base (1) forming the central structure of the device, with the hollow metal rods (5) serving as current collectors. The rectangular narrow stack geometry electrode (6) allows to carry out the pre-metallisation stage necessary to create the SEI, and the subsequent cycle stage in the same device, without reopening it.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

Geometric distribution is one of the parameters with the greatest impact on both the properties and the behaviour of energy storage devices.

Parameters such as the maximum distance between the ion flow and the current collector, or the distance between collectors have been shown to affect the electrochemical response of the device.

Other factors such as packing density, cell internal volume utilisation, internal resistance or thermal behaviour are also dependent on the device's geometry.

Long distances between electrodes have been shown to limit the mobility and spreading of ions by increasing electrical resistance, therefore, an optimal geometrical design that ensures proper electrochemical cell functioning is crucial.

Currently, the known state-of-the-art energy storage device designs are as follows:
Coin or Button Cell Design: This type of device has a circular geometry of 10 mm in diameter and is mainly focused on research due to its easy handling, quick assembly and low cost.

It has a positive electrode, a separator and a negative electrode.

This type of devices do not contain any type of security venting and do not allow fast charging.

Their main applications are medical implants, watches, hearing aids, car keys and memory storage devices.
Cylindrical Cell Design: This packaging design is one of the most commonly used today. Some of its advantages are the simplicity of assembly and good mechanical stability.

The outer housing allows for high internal pressures without deformation.

This type of design has a single plate of both electrodes which, together with the separator, are wound inside a cylindrical housing. There are standard measurements for this type of cells, although they can be adapted to the desired size.

This type of design offers a long life cycle and is affordable.

However, they are bulky and have a low packing density, due to the chambers created when wounding the electrodes.

The most common applications for this type of devices are power tools, medical devices, or laptop computers.
Pouch or Prismatic Cell Design: This design also consists of a single plate of both electrodes. It is the most widely used design in the industry, and the most popular design in hybrid and electric vehicles today. The plates are rolled into a flexible bag. This packaging improves the use of space compared to cylindrical cells; however, they are also more expensive to manufacture, less efficient in thermal management and have shorter life cycles. These cells must be temporarily added a “gas bag” on one side. The function of this complement is to collect the gases formed during the creation of the solid electrolyte interface in the first charging cycles. This type of design does not have standard dimensions and can be custom-made depending on the application.

In all said cases, the design or geometry changes, however, the concept is the same: Two single electrodes with a separator and two single collectors in contact with the exterior.

The current collectors are located at the end of the plate, this being the only point from which the energy provided by the cell can be drawn.

These systems pose several issues:
increased internal resistance of the cell.
in all these designs, the current collectors are perpendicular to the energy density flow created by the transport of ions between the two electrodes.

All these issues are solved by the rectangular geometric design proposed by this invention, which is technically built by current collectors that are two metal through rods passing through all the electrodes.

The collectors go in the same direction as the ion flow between anode and cathode.

In addition, the contact between the collectors and the electrodes is individually direct with each of them ensuring even current distribution. This significantly decreases internal resistance and, therefore, the current drawn from the device is higher.

### FIELD OF THE INVENTION

The industry sector of the invention is that of the electrical energy storage devices, especially, the manufacture of batteries, electrical capacitors or hybrid capacitors.

### SUBJECT MATTER OF THE INVENTION

The invention is an electrochemical device for storing electrical energy in rectangular geometric cells with a specific rectangular geometry, which allows the electrodes to be stacked vertically by the centre part of the electrode and include metal plates in the side chambers.

This way, both the electrodes and the metal are in contact with a current collector, and, depending on the connection, an electrochemical pre-metallisation process or charge transfer between electrodes can be carried out without opening the device for adding electrolytes.
The particular rectangular electrochemical cell geometry constitutes an embodiment that, in addition to being groundbreaking, significantly improves the energy efficiency of existing devices.

This device is valid for any type of electrochemical setting, be it batteries, super-capacitors or hybrids between the two.

### BRIEF SUMMARY OF THE INVENTION

The invention referred to in this project description is an electrochemical device for storing electrical energy in rectangular geometric cells with a specific rectangular geometry, called narrow stack geometry, which allows electrodes to be stacked vertically by their centre part and include metal plates in the side chambers.

Therefore, both, the electrodes and the metal are in contact with a current collector, and, depending on the connection, an electrochemical pre-metallisation process or charge transfer between electrodes can be carried out.

The particular rectangular electrochemical cell geometry constitutes an embodiment that, in addition to being groundbreaking, significantly improves the energy efficiency of existing devices.

The geometry proposed by this invention is intended to solve this problem by incorporating, within it, a space intended for deposition of the metal in case external metallisation is necessary. Therefore, within the cell volume, both the main electrodes and the metal can be included.

Currently, using carbonaceous materials of high porosity, but there is a problem of capacity loss of the devices caused by the formation of the solid electrolyte interface (SEI).
This problem is solved by metallising the anode. To carry out this process, it is necessary to connect the anodic material with the metal through an external circuit. With the existing electrochemical cell designs, this anode metallisation must be performed at a stage outside the formation stage since, inside the cell, there is only room for two electrodes.
Furthermore, if external metallisation is required, we only need to connect the external electrical circuit to the metal and to the electrode to be metallised. This process removes the loss of capacity caused by the formation of the solid-electrolyte interface since, once this layer has been formed, the external electrical circuit connects the main electrodes to each other and begin to perform charge and discharge cycles.

Another benefit offered by this cell design is the way the electrical current is drawn. Generally, the current collector is in contact with one end of the electrode and exits outward in a direction perpendicular to the ion flow.

This time, the current collectors are two metal through rods that go through all the electrodes.

The collectors go in the same direction as the ion flow between anode and cathode.

In addition, the contact between the collectors and the electrodes is individually direct with each of them ensuring even current distribution.

This significantly decreases internal resistance and, therefore, the current drawn from the device is higher.

### BRIEF DESCRIPTION OF THE DRAWINGS

In order to complement the description being made and in order to assist a better understanding of the features of the invention, two sheets of drawings are added to this descriptive report, as an integral part thereof, in which elements are indicated with identical references and where, including but not limited to, the following has been represented:

FIG. 1—Cut-off view of the device and its component parts

FIG. 2—Isometric view of the geometric arrangement of vertically stacked electrodes, and through rods. (Narrow stack geometry).

FIG. 3—Isometric view of the mounted device

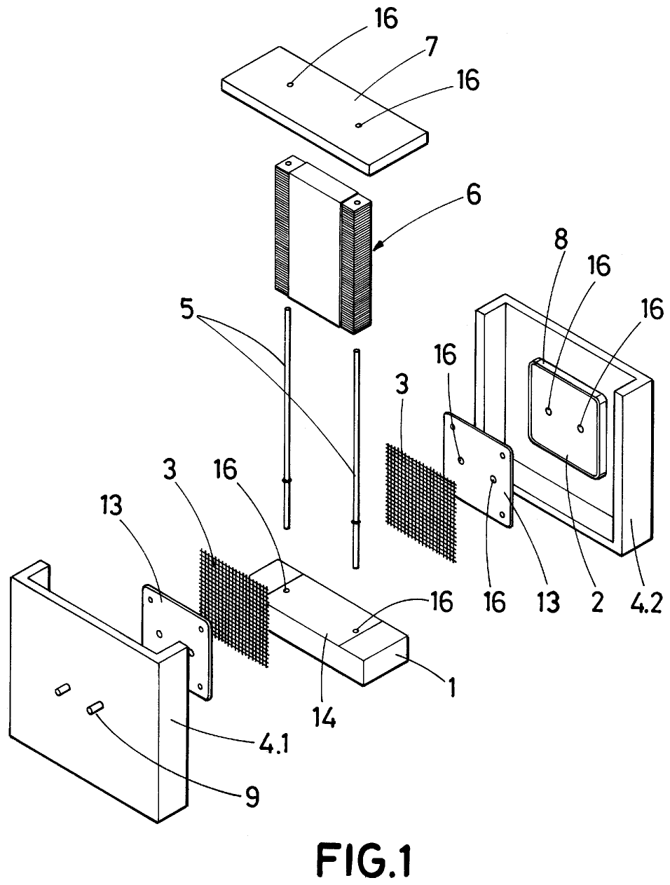

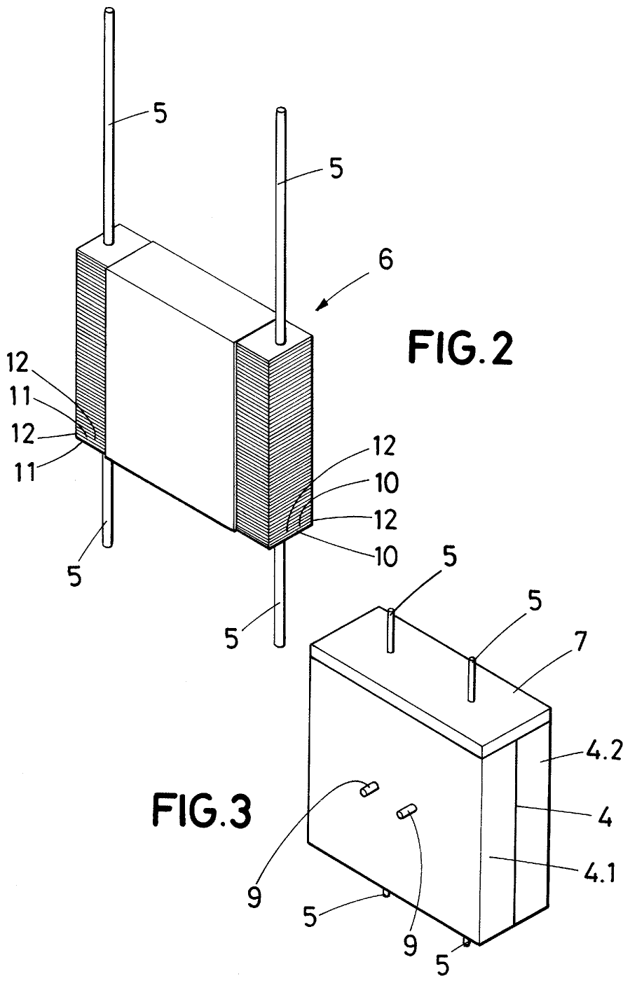

And in these figures, the same elements are identified with identical numbering:
(1).—backbone structure,
(2).—metal plate
(3).—metal support grid
(4).—hermetic and robust housing.
(4.1).—front side,
(4.2).—rear side
(5).—hollow metal through rods,
(6).—electrode stack,
(7).—top cover of the container,
(8).—metal chamber,
(9).—electrode connection,
(10).—positive electrode,
(11).—negative electrode,
(12).—separating paper,
(13)—metal-ion sheet,
(14)—metal substrate
(16)—through holes.

### DETAILED DESCRIPTION OF THE INVENTION

### Preferred Embodiment of this Invention

The invention referred to in this descriptive report is an electrochemical device for storing electrical energy by means of a new arrangement of rectangular geometric cells, called the narrow stack geometry, that allows the electrodes to be stacked vertically in their centre part.

In a preferred embodiment, the electrochemical device for storing electrical energy in rectangular geometric cells, is formed from a robust straight rectangular parallelepiped-shaped housing (4), which can be hermetically sealed and which will house the rest of the components.

Said robust housing (4) is formed by a base (1), two front and rear sides (4.1 and (4.2) and a cover (7).
On the base (1), hollow metal rods run through the holes (16) at the ends thereof (5). The function of said metal through rods (5) is to serve as current collectors and the electrodes will be deposited on a metal substrate (14). In addition, and as an important function, said hollow metal rods (5) will serve as a means for cooling the assembly, such that air or coolant fluid may circulate inside the assembly.

The electrodes would be deposited always following the same sequence:

On the hollow metal rod (5) the positive electrode is inserted, then the separating element (which can be paper), the positive electrode-separating element and so on.

On the other hollow metal rod (5) the negative electrode is inserted, then the separating element (which can be paper), the negative electrode-separating element and so on.

More or fewer electrodes can be stacked depending on their thickness, and this device can overlap a large number of electrodes in a reduced space, ensuring high performance.

All electrodes will be deposited on a metal substrate (14) and, depending on the material used, will serve as an anode or cathode of the device.

The electrodes acting as anodes are always inserted on the same rod and all the flaps would be on the same side; those acting as cathodes are inserted, all of them, on the opposite rod. This way, one of the rods will interconnect all the anodes and the other all the cathodes.
The Stack of electrodes (6) thus built, is what constitutes the so-called “narrow stack” geometry and would fit into the base (1) forming the central structure of the device.
   On the two sides (4.1) and (4.2) and on the inner part thereof there is a chamber (8) in which a metal plate (2) is incorporated, and on such metal plate, goes a metal-ion sheet (13) suitable for this type of devices, such as lithium, sodium, or any type of metal suitable for an energy storage device. A grid (3) is used to secure the metal-ion sheet (13).

The grid (3) serves as a support for said metal-ion sheet (13) and, at the same time, prevents the metal sheet (2) from falling off and creating a potential short circuit in the device when it comes into direct contact with one of the electrodes of the central stack.

Likewise, the grid (3) is used to press it against the metal plate (2) incorporated within the chamber (8), which will be in contact with one of the external collectors (9). Thus, when an electric current is applied to one of the baseline collectors (9), an even current distribution will be generated up to the metal-ion sheet, and it will come into operation inside the device.

The grid (3) is screwed to the metal plate (2) by the four holes on the edges of the corners and the metal-ion sheet (13) is locked between the two holes.

The two central holes in the metal plate (2) serve to make the external connection (9) of the metal-ion sheet (13). This connection can be carried out, either with a through screw, a pin, or any other element, provided that it is metallic.
Once the metal-ion sheets (13) have been incorporated into the side covers (4.1) and (4.2) the device, the two side covers must be sealed, and the central structure of the device, which includes the stack and the metal through rods (5), must be fitted inside. All of this must be done in an inert atmosphere to prevent metal-ion oxidation.
   Finally, the electrolyte is incorporated and the top cover (7) sealed, all this also in an inert atmosphere.

Both, the side covers (4.1) and (4.2) the top cover (7) must be of a material resistant to oxidizing conditions and with good mechanical resistance, to avoid deformations and high pressures.

The material can be plastic or any other type of material that fulfils these expectations, although it is advisable that it is not an electric conductor, to prevent contact between the two metal rods (5), either between them or with the side collectors (9), which may cause a potential short circuit, preventing the operation of the device.

The connections for the operation of the device are as follows:
The electrode stack (6) with rectangular narrow stack geometry, allows carrying out the pre-metallisation stage, necessary to create the SEI, and the subsequent cycling stage in the same device, without reopening it.

Generally, it is necessary to carry out the pre-metallisation stage, and then open the device to incorporate more electrolyte, since part of it is consumed in this phase, and there are no devices that allow connecting baseline electrodes to carry out this phase.

The collectors (9) located on the side covers (4.1) and (4.2) enable the pre-metallisation stage to be carried out, acting as a negative current collector.

In this case, the collectors (9) must be connected to the negative pole of a voltage source and the metal rod (5), which interconnects all the electrodes that will serve as anodes of the device, to the positive pole of the current. This way, a process of ion intercalation occurs in the structure of the anode material, which will result in the creation of a solid-electrolyte interface (SEI).

When this phase is completed, it is not necessary to open the device as in the existing energy storage devices, but it is possible to directly connect the anode and the cathode of the device by means of the through rods (5) so that a charge and discharge cycling process takes place between them.

In this case, the metal rod (5) that interconnects all the electrodes serving as an anode, will be connected to the negative pole of the voltage source, and the metal rod (5) that interconnects all the electrodes serving as a cathode, shall be connected to the positive pole of the voltage source.

It is also possible to make an auxiliary connection to any of the collectors (9) to monitor the internal behaviour of the device, with respect to that baseline electrode.

This type of narrow stack setting is valid for any type of energy storage devices (batteries, electric capacitors or hybrid capacitors).
Having sufficiently described the nature of the invention, as well as the manner of its implementation, it should be noted that the provisions set out above and represented in the attached drawings are subject to change in detail, as long as they do not alter their fundamental principles set out in the preceding paragraphs and summarised in the following claims.

1. An electrochemical device for storing electrical energy in rectangular geometric cells, narrow stack geometry, comprising
a straight sturdy rectangular parallelepiped-shaped housing (4) made of a material resistant to oxidizing conditions with good mechanical strength, and which must be hermetically sealed, housing the rest of the components, the robust housing (4) consisting of
a base (1), with two hollow metal rods (5) run over a metal substrate (14) at the bottom of the base (1) and through the through holes (16) of the base; a positive electrode is inserted, followed by a separating element and so on, while by the other hollow metal bar (5) a negative electrode is inserted, followed by a separating element and so on; the number of electrodes required can be stacked in a small space forming an electrode stack (6), narrow stack geometry, which would fit into the base (1) forming the central structure of the device, with the rods (5) serving as current collectors.
two front and rear faces (4.1 and (4.2) with a hole on the inside (8) where a metal plate is incorporated (2) and on this metal plate,
a sheet of a metal-ion (13) and as attachment of the metal-ion sheet (13), a grid (3) is used, screwed to the metal plate (2) clamping each other to the metal-ion sheet (13) and where the two central holes with the metal plate (2) serve to make the external connection (9) of the metal-ion sheet (13) by means of a metal pin
a cover (7)

2. The device according to claim 1 wherein it features a metal-ion sheet (13) in lithium, sodium, or any type of metal suitable for an energy storage device.

3. The device according to claim 1 wherein the electrodes serving as anodes, are always inserted on the same rod, remaining all flaps on the same side, and those serving as cathodes are inserted, all of them, on the opposite rod, so that one of the rods will interconnect all anodes and the other all cathodes.

4. The device according to claim 1 wherein the grid (3) presses the metal-ion sheet (13) against the metal plate (2) built into the chamber (8), which is in contact with one of the external collectors (9), so that when applying an electrical current to one of the baseline collectors (9), an even current distribution is generated up to the metal-ion sheet (13), and the sheet will come into operation inside the device, with the grid (3) screwed to the metal plate (2) by the four holes present at the edges of the corners, between which the metal-ion sheet is clamped (13).

5. The device according to claim 1 wherein, the two central holes in the metal plate (2), serving to make the external connection (9) of the metal-ion sheet (13) and this connection is made by means of a through screw, a pin, or any other similar metallic element.

6. The device according to claim 5 wherein once metal-ion sheets (13) are incorporated into the side covers (4.1) and (4.2) of the device, these covers are sealed by fitting inside them, the central structure of the device, which includes the stack and metal through rods (5), in an inert atmosphere to prevent oxidation of the metal-ion plate (13), and finally, the electrolyte and seal the top cover (7), all also in an inert atmosphere.

7. The device according to claim 6 wherein such geometry, allows carrying out the pre-metallisation stage, necessary to create the SEI, and the subsequent cycling stage in the same device, without the need to reopen it, since the collectors (9) located on the side covers (4.1) and (4.2) allow the pre-metallisation stage to be carried out, serving as a negative current collector, and the collectors (9) must be connected to the negative pole of a voltage source, and the metal through rod (5), which interconnects all the electrodes that will serve as anodes of the device, to the positive pole of the current, producing an ion intercalation process in the structure of the anode material, which will result in the creation of a solid-electrolyte interface (SEI). The device is not required to be opened, but the anode and cathode of the device are connected directly by the through rods (5) so that a charging and discharging cycle process takes place between the two.

8. The device according to claim 6 wherein the metal rod (5) interconnecting all the electrodes serving as cathodes, will be connected to the positive pole of the voltage source.

9. The device according to claim 1 wherein to carry out a monitoring of the internal behaviour of the device, an auxiliary connection is made to any of the collectors (9).

10. The device according to claim 1 wherein this narrow stack geometry setting is valid for any type of energy storage device, either batteries, electric capacitors or hybrid capacitors.

11. The device according to claim 1 wherein the hollow metal rods (5) will serve as a means to cool the assembly when circulating through its hollow interior air or cooling fluid.
